(19) United States
(12) Patent Application Publication
(10) Pub. No.: US 2025/0010783 A1
(43) Pub. Date: Jan. 9, 2025

(54) CUP HOLDER AND METHOD FOR ADJUSTING THE HEIGHT OF A CUP HOLDER

(71) Applicant: Dr. Ing. h.c. F. Porsche Aktiengesellschaft, Stuttgart (DE)

(72) Inventor: Achim KLING, Neuweiler-Agenbach (DE)

(21) Appl. No.: 18/760,048

(22) Filed: Jul. 1, 2024

(30) Foreign Application Priority Data
Jul. 7, 2023 (DE) 10 2023 117 960.8

(51) Int. Cl. B60N 3/10

(52) U.S. Cl. CPC B60N 3/105; B60N 3/103

(57) ABSTRACT

A cup holder for a central console of a motor vehicle, including a receiving body configured to be inserted in a recess of the central console for delimiting a receiving volume for at least one beverage container. The receiving body has a first fastener acting away from the receiving volume in a first direction for fastening to the central console and a second fastener acting away from the receiving volume in a second direction opposite to the first direction for fastening to the central console. The first fastener and the second fastener are positioned at different heights in a Z-direction and are substantially uniformly shaped.

### CROSS REFERENCE TO RELATED APPLICATIONS

This application claims benefit to German Patent Application No. DE 10 2023 117 960.8, filed on Jul. 7, 2023, which is hereby incorporated by reference herein.

### FIELD

The invention relates to a cup holder, with the aid of which beverage containers can be accommodated at different heights in a central console of a motor vehicle, and to a method with the aid of which the height adjustment can be achieved.

### BACKGROUND

US 2005/0224509 A1 discloses a cup holder for a central console of a motor vehicle, in which different bases for the cup holder can be inserted into a recess in the central console at different heights in order to adapt the cup holder to be used with beverage containers of different heights.

There is a constant need to be able to adjust the height of a central console cup holder as simply and robustly as possible.

### SUMMARY

In an embodiment, the present disclosure provides a cup holder for a central console of a motor vehicle, comprising a receiving body configured to be inserted in a recess of the central console for delimiting a receiving volume for at least one beverage container. The receiving body has a first fastener acting away from the receiving volume in a first direction for fastening to the central console and a second fastener acting away from the receiving volume in a second direction opposite to the first direction for fastening to the central console. The first fastener and the second fastener are positioned at different heights in a Z-direction and are substantially uniformly shaped.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic perspective sectional view of a cup holder arrangement;

FIG. 2 illustrates a schematic side view of a cup holder for the cup holder arrangement in FIG. 1;

FIG. 3 illustrates a schematic side sectional view of a part of the cup holder arrangement from FIG. 1 at a first point in time;

FIG. 4 illustrates a schematic side sectional view of a part of the cup holder arrangement from FIG. 1 at a second point in time;

FIG. 5 illustrates a schematic side sectional view of a part of the cup holder arrangement from FIG. 1 at a third point in time;

FIG. 6 illustrates a schematic side sectional view of a part of the cup holder arrangement from FIG. 1 at a fourth point in time; and

FIG. 7 illustrates a schematic side sectional view of a detail of the cup holder arrangement from FIG. 1.

### DETAILED DESCRIPTION

In an embodiment, the present invention provides measures that enable a simple and robust height adjustment for a cup holder of a central console.

An aspect of the invention relates to a cup holder for a central console of a motor vehicle, having a receiving body which can be inserted in a recess of the central console for delimiting a receiving volume for at least one beverage container, wherein the receiving body has a first fastening element acting away from the receiving volume in a first direction for fastening to the central console and a second fastening element acting away from the receiving volume in a second direction opposite to the first direction for fastening to the central console, wherein the first fastening element and the second fastening element are positioned at different heights in the Z-direction and are substantially uniformly shaped.

The recess of the central console into which the cup holder is inserted can substantially correspond to the outer contour of the cup holder's receiving body. The first fastening element and the second fastening element can interact with corresponding elements of the central console, in particular in the region of the recess, in order to detachably fasten the cup holder to the central console in the recess. Since the first fastening element and the second fastening element have substantially the same shape, both the first fastening element and the second fastening element can interact with the same corresponding element of the central console. Since the first fastening element and the second fastening element are positioned at different heights in the Z direction, the receiving body can be at different heights relative to the recess of the central console, depending on whether the first fastening element or the second fastening element is fastened to the same corresponding element of the central console. The positioning of the first fastening element and the second fastening element relative to the receiving volume of the receiving body can be coordinated such that the receiving body only needs to be rotated by 180° about a vertical Z-axis in order to allow either the first fastening element or the second fastening element to interact with the same corresponding element of the central console under consideration. The cup holder can thus be very easily moved between two different heights relative to the central console by simply rotating it 180° so that the other fastening element interacts with the corresponding element of the central console in question. The risk of incorrect operation or damage to the cup holder during height adjustment is very low, meaning that the height adjustment of the cup holder is very robust. The uniformly shaped fastening elements provided at different heights make it possible to adjust the height of the cup holder in the central console very easily and robustly by rotating the cup holder.

In particular, the receiving body of the cup holder can have an substantially cuboid outer contour, to which an inner contour of the recess of the central console preferably corresponds. The receiving body can be substantially trough-shaped, wherein an inner contour of the receiving body delimiting the receiving volume can be adapted to the shape of one beverage container or several different beverage containers at different locations and/or several differently shaped beverage containers at the same location within the receiving volume. If the drinks container to be received has a low height, it is advisable to fasten the cup holder to the central console in a raised position so that the drinks container can be easily reached. If the beverage container to be received should have a greater height, it is advisable to fasten the cup holder in a recessed position with the central console so that the cup holder does not protrude too much from the central console and possibly block the closing of a cover to cover the receiving volume.

The respective fastening element of the receiving body can be provided on an outer side of the receiving body outside the receiving volume. The fastening element can be designed as a male part interacting with a female part of a fastening or vice versa. The fastening formed with the respective fastening element is designed to be detachable in particular, for example by providing a relatively movable part for opening and closing one of the fastenings in the case of at least one fastening. This means that at least one fastening of the receiving body to the central console can be designed as a detachable lock, detachable locking mechanism, detachable clip connection, detachable latching mechanism or similar. Preferably, the first fastening element can point in the X direction and the second fastening element can point opposite to the X direction or vice versa. Since the central console has an extension that is essentially aligned in the X direction, the receiving body can also have a greater extension in the X direction than in the Y direction, so that the first fastening element and the second fastening element are positioned as far apart as possible.

An X-direction is understood to be a coordinate direction along a longitudinal axis of a motor vehicle when the cup holder is installed in the motor vehicle. The X-direction extends substantially horizontally when the motor vehicle is parked on a flat horizontal surface. A Y-direction is understood to be a coordinate direction along a transverse axis of a motor vehicle when the cup holder is installed in the motor vehicle. The Y-direction extends substantially horizontally when the motor vehicle is parked on a flat horizontal surface. A Z-direction is understood to be a coordinate direction along a vertical axis of a motor vehicle when the cup holder is installed in the motor vehicle. The Z-direction extends substantially vertically when the motor vehicle is parked on a flat horizontal surface. The X-direction, the Y-direction, and the Z-direction are oriented orthogonally to one another.

In particular, the cup holder can be completely removed from the central console so that only the recess in the central console remains. This makes it possible to receive rather bulky objects in the recess, which would not fit so well in the receiving volume contoured to hold beverage containers. Preferably, the cup holder can be replaced with another device with the same fastening technology, i.e. with the uniformly shaped first fastening element and second fastening element. The other device can be used to provide a different functionality from a cup holder. For example, a charging infrastructure for charging electronic devices, in particular smartphones, can be used in the recess of the central console instead of the cup holder. In the manner of a modular system, different functionalities can be provided individually by fastening various devices in the recess, which are prepared for different functions.

In particular, the first fastening element and the second fastening element are shaped as fastening projections projecting substantially in a horizontal direction, in particular in the X direction, for insertion into a corresponding fastening opening in the central console. The fastening elements can thus be shaped as the male part of a fastening. This makes it easier to provide several fastening openings at different heights in the central console, in particular in a wall of the recess of the central console, so that the receiving body can be fastened to the central console both in the recessed position and in the raised position via the first fastening element and via the second fastening element. This ensures that the cup holder is securely and robustly fastened in the recess of the central console without any protruding component of the central console making it difficult to insert the cup holder into the recessed position.

Preferably, the first fastening element and the second fastening element are positioned laterally offset in a plan view in the Z direction to a center line of the receiving volume, in particular point-symmetrically. The respective fastening of the cup holder in the recess of the central console with the aid of the respectively assigned first fastening element and second fastening element is thus not carried out centrally in a side wall of the recess, but in the vicinity of a corner of the recess. The forces occurring in the fastening can thus be supported in a particularly rigid and stable region of the central console.

The receiving volume is preferably shaped to receive at least two beverage containers arranged one behind the other in the X-direction. This makes it possible to take advantage of the fact that the central console generally has a greater extension in the X direction than in the Y direction. This makes it possible, for example, to receive a drinks container for both the driver and the front passenger.

An aspect of the invention relates to a cup holder arrangement for a motor vehicle, with a central console forming a recess and a cup holder detachably inserted in the recess, which can be designed and further developed as described above, wherein it is provided in particular that the central console has a fastening mechanism and a lower fastening contour and/or a higher fastening contour, wherein, in a lowered position of the cup holder, the first fastening element interacts with the fastening mechanism and the second fastening element interacts with the lower fastening contour and/or, in a raised position of the cup holder, the second fastening element interacts with the fastening mechanism and the first fastening element interacts with the higher fastening contour. The cup holder arrangement, in particular the central console and/or the cup holder, can in particular be designed and further developed as described above. The uniformly shaped fastening elements provided at different heights make it possible to adjust the height of the cup holder in the central console very easily and robustly by rotating the cup holder.

Since the cup holder can be detachably fastened in the cup holder arrangement, the cup holder can easily be replaced with another module which can also be inserted in the recess and preferably can also cooperate with the lower fastening contour and/or with the upper fastening contour for fastening. The other module can, for example, be shaped to store objects that are shaped differently to beverage containers. For example, the other module can be designed to receive mobile end devices, in particular tablets or smartphones, and preferably enable inductive charging of the mobile end device. For this purpose, the other module can comprise a battery-operated inductive charging device and/or an inductive charging device connected to an on-board network of the motor vehicle, which is provided in particular underneath a floor.

In particular, it is provided that the first fastening element and/or second fastening element cooperating with the fastening contour form a joint for pivoting the cup holder towards the fastening mechanism and/or away from the fastening mechanism. The receiving body can first be hinged to the fastening contour with the aid of one fastening element and pivoted towards the fastening mechanism with the other fastening element, so that the other fastening element can engage in the fastening mechanism with a corresponding swing, for example for clipping and/or latching with the fastening mechanism. In particular, the fastening mechanism can be designed to be relatively movable at least in part, for example to spring away elastically.

Preferably, the fastening mechanism forms a releasable latch, wherein in particular the latch has a closed initial state with the aid of a spring element. With the help of the spring element, a part of the fastening mechanism can be moved away elastically, for example by hand, against the spring force of the spring element, so that the cooperating fastening element of the cup holder can engage in the fastening mechanism. The spring force of the spring element can then cause the elastically bent part of the fastening mechanism to snap back to close the latch. This results in a robust, secure and simple fastening that can be easily detached again.

An aspect of the invention relates to a method for adjusting the height of a cup holder, which can be designed and further developed in particular as described above, in a cup holder arrangement, which can be designed and further developed as described above, in which the cup holder is pulled out of the recess of the central console in the Z direction, subsequently the cup holder is rotated by 180° about a Z axis and subsequently inserted into the recess of the central console in the Z direction. In particular, the method can be designed and further developed as described above. Thanks to the uniformly shaped fastening elements of the cup holder provided at different heights, a very easy and robust height adjustment of the cup holder in the central console can be achieved by rotating the cup holder.

Preferably, a fastening of the cup holder to the central console, especially in the recess, is loosened before pulling out and a fastening of the cup holder to the central console, especially in the recess, is closed after insertion. The cup holder can thus be secured in the recess of the central console, wherein the fastening for the height adjustment of the cup holder relative to the central console can be released again.

In particular, during pulling out and/or insertion, the cup holder is pivoted at least temporarily about a horizontal axis, in particular to loosen the fastening and/or to close the fastening. The swivel movement can be used to attach the detachable fastening mechanism with a little momentum, making it easier to fasten the cup holder to the recess in the central console.

Embodiments of the invention will now be described with reference to the accompanying drawings, wherein the features described hereinafter can represent an aspect of the invention both individually and in combination.

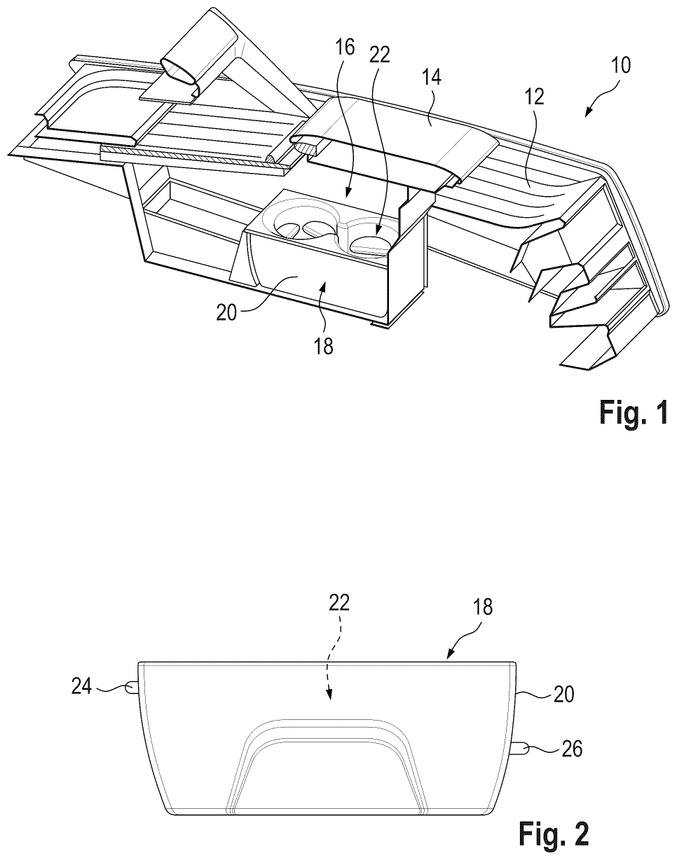

The cup holder arrangement 10 shown in FIG. 1 can be installed in a motor vehicle. The cup holder arrangement 10 can have a central console 12, which has a recess 16 that can be closed with a cover 14. A cup holder 18 can be inserted into the recess 16 and detachably fastened. The cup holder 18 can comprise a receiving body 20, which delimits a receiving volume 22. In the illustrated example embodiment, the receiving body 20 is delimited to the receiving volume 22 such that two can-shaped beverage containers can be received one behind the other in the X direction.

As shown in FIG. 2, the receiving body 20 of the cup holder 18 can comprise a first fastening element 24 and a second fastening element 26 on its sides pointing in the X direction. The first fastening element 24 and the second fastening element 26 face away from each other and away from the receiving volume 22. The first fastening element 24 and the second fastening element 26 are each shaped as a projecting fastening projection, wherein the first fastening element 24 and the second fastening element 26 are shaped substantially identically. However, the first fastening element 24 and the second fastening element 26 are substantially mirror images of each other and are positioned at different heights in the Z direction. Preferably, the first fastening element 24 and the second fastening element 26 are also positioned offset to each other in the Y-direction.

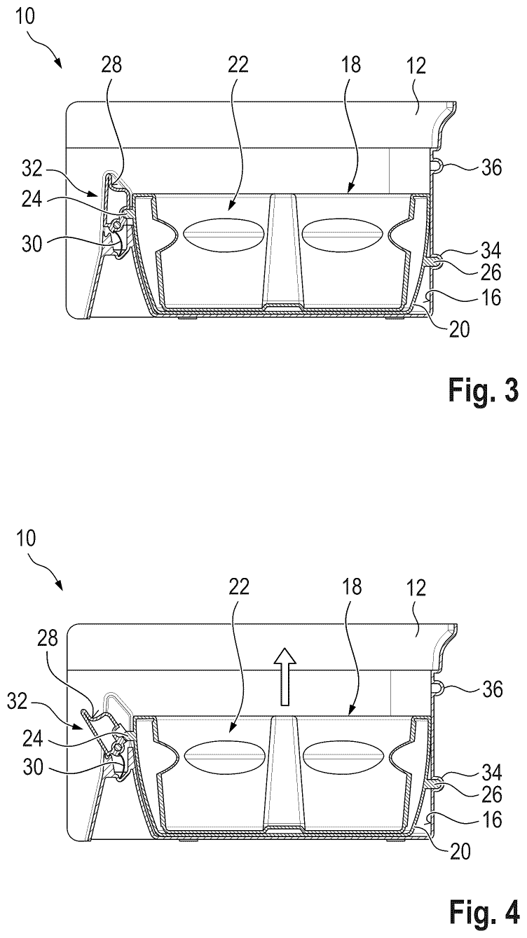

As shown in FIG. 3, the receiving body 20 of the cup holder 18 can be positioned in a recessed position in the recess 16 of the central console 12. In the recessed position, for example, the first fastening element 24 is detachably fastened, in particular latched, in a fastening mechanism 32 that can be actuated against a spring element 30 at a grip region 28, while the second fastening element 24 is inserted in a lower fastening contour 34. The cup holder 18 is thus fastened in the central console 12 so that it cannot move.

As shown in FIG. 4, the fastening mechanism 32 can be released by manually applying a force to the grip region 28, with the aid of which a part of the fastening mechanism 32 can be pivoted against the spring force of the spring element 30. The first fastening element 24 is thus exposed so that the receiving body 20 of the cup holder 18 can be removed from the recess 16. In particular, the receiving body 20 can initially be swiveled slightly around a swivel axis. The pivot axis runs through the first fastening element 24 inserted in the lower fastening contour 34, forming a joint in this respect.

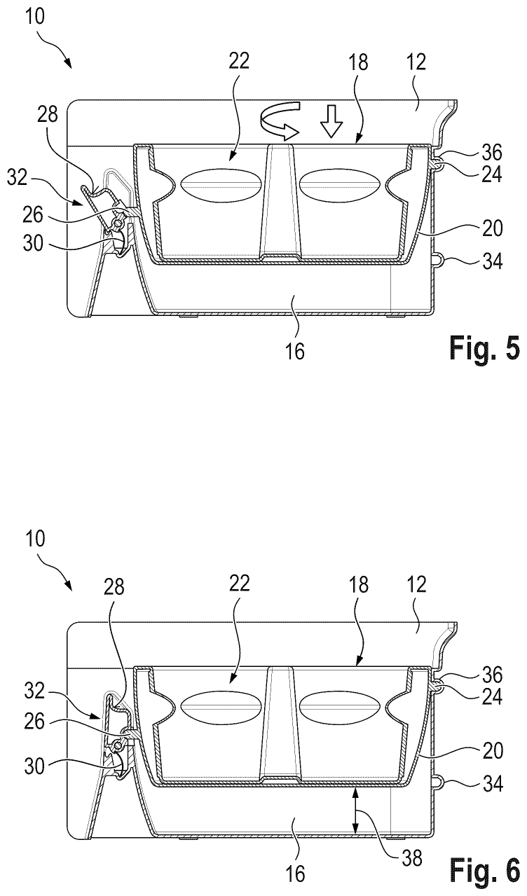

As shown in FIG. 5, the cup holder 18 can be rotated by 180° about an axis running in the Z direction and reinserted into the recess 16. This allows the second fastening element 26 to cooperate with the fastening mechanism 32, while in particular the first fastening element cooperates with a higher fastening contour 36 provided above the lower fastening contour 34. The lower fastening contour 34 and the higher fastening contour 36 are substantially identically shaped, fulfill comparable functions and, in particular, are formed in one piece by the central console 12.

As shown in FIG. 6, the fastening mechanism 32 can be closed in the region of the second fastening means 26, so that the cup holder 18 is fastened to the central console 12 in a position raised by a distance 38 in the Z-direction compared to the recessed position shown in FIG. 3.

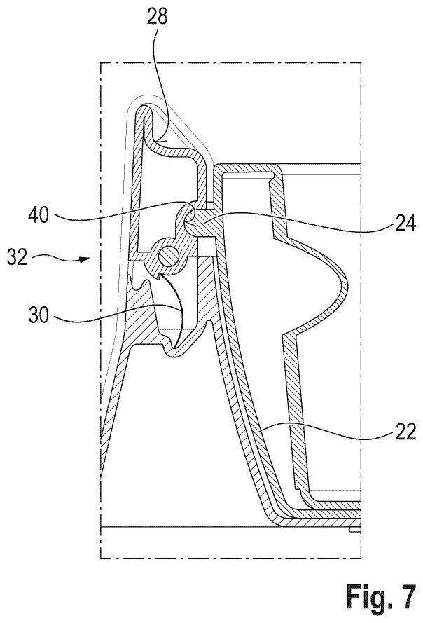

As shown in FIG. 7, the fastening mechanism 32 can have a contour 40 corresponding to the lower fastening contour 34 and the higher fastening contour 36, into which the first fastening element 24 or the second fastening element 26 can engage in the closed position of the fastening mechanism 32.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cup holder for a central console of a motor vehicle, comprising:
a receiving body configured to be inserted in a recess of the central console for delimiting a receiving volume for at least one beverage container,
wherein the receiving body has a first fastener acting away from the receiving volume in a first direction for fastening to the central console and a second fastener acting away from the receiving volume in a second direction opposite to the first direction for fastening to the central console, and
wherein the first fastener and the second fastener are positioned at different heights in a Z-direction and are substantially uniformly shaped.

2. The cup holder according to claim 1, wherein the first fastener and the second fastener are shaped as fastening projections projecting substantially in an X-direction for insertion into a corresponding fastening opening of the central console.

3. The cup holder according to claim 1, wherein the first fastener and the second fastener are positioned laterally offset in a plan view in the Z-direction relative to a center line of the receiving volume.

4. The cup holder according to claim 1, wherein the receiving volume is shaped to receive at least two beverage containers provided one behind the other in an X-direction.

5. A cup holder arrangement for a motor vehicle, comprising:
a central console forming a recess; and
the cup holder according to claim 1 detachably inserted in the recess,
wherein the central console comprises a fastening mechanism as well as a lower fastening contour and a higher fastening contour,
wherein, in a lowered position of the cup holder, the first fastener cooperates with the fastening mechanism and the second fastener cooperates with the lower fastening contour, and
wherein, in a raised position of the cup holder, the second fastener cooperates with the fastening mechanism and the first fastener cooperates with the higher fastening contour.

6. The cup holder arrangement according to claim 5, wherein the first fastener and/or second fastener cooperating with the fastening contour form a joint for pivoting the cup holder towards and/or away from the fastening mechanism.

7. The cup holder arrangement according to claim 5, wherein the fastening mechanism forms a releasable latch, and wherein the latch has a closed initial state with the aid of a spring element.

8. A method for adjusting the height of a cup holder in the cup holder arrangement according to claim 5, the method comprising:
pulling the cup holder out of the recess of the central console in the Z-direction;
subsequently rotating the cup holder by 180° about a Z-axis; and
subsequently inserting the cup holder into the recess of the central console in the Z-direction.

9. The method according to claim 8, comprising loosening a fastening of the cup holder to the central console before pulling out and closing the fastening of the cup holder to the central console after insertion.

10. The method according to claim 8, comprising pivoting the cup holder during pulling out and/or during insertion at least temporarily about a horizontal axis for loosening the fastening and/or for closing the fastening.

11. The cup holder according to claim 3, wherein the first fastener and the second fastener are positioned point-symmetrically in the plan view in the Z-direction relative to the center line of the receiving volume.
